(19) United States
(12) Patent Application Publication
(10) Pub. No.: US 2024/0037510 A1
(43) Pub. Date: Feb. 1, 2024

(54) METHOD AND APPARATUS FOR DETERMINING APPOINTMENT ATTENDANCE PROBABILITY

(71) Applicant: HERE GLOBAL B.V., Eindhoven (NL)

(72) Inventors: Leon STENNETH, Chicago, IL (US); Jerome Beaurepaire, Nantes (FR); Jeremy Michael YOUNG, Chicago, IL (US)

(73) Assignee: HERE GLOBAL B.V., Eindhoven (NL)

(21) Appl. No.: 17/874,612

(22) Filed: Jul. 27, 2022

(51) Int. Cl. G06Q 10/10; G01C 21/36

(52) U.S. Cl. CPC G06Q 10/1095; G01C 21/36

(57) ABSTRACT

A method, apparatus, and user interface for determining appointment attendance probability comprising obtaining an indication of least a first location and second location of an end user; wherein the first location and second location are obtained at a predefined time interval, obtaining end user driving profile data, obtaining end user appointment data, determining appointment attendance probability based, at least in part, on the obtained first location, second location, end user appointment data, and end user driving profile data, and updating at least one database with the determined appointment attendance probability.

### TECHNOLOGICAL FIELD

An example embodiment relates generally to a method, apparatus, computer readable storage medium, user interface and computer program product for determining appointment attendance probability and, more particularly, for determining appointment attendance probability based upon various types of end user data.

### BACKGROUND

Modern vehicles include a plurality of different types of sensors for collecting a wide variety of information. These sensors include location sensors, such as global positioning system (GPS) sensors, configured to determine the location of the vehicle. Based upon the location of the vehicle, a variety of navigational, mapping and other services may be provided for manually driven vehicles as well as the provision of navigation and control of autonomous or semi-autonomous vehicles. Other examples of sensors include cameras or other imaging sensors that capture images of the environment including objects in the vicinity of the vehicle. The images that are captured may be utilized to determine the location of the vehicle with more precision. A more precise determination of the vehicle location may be useful in conjunction with the provision of navigational, mapping and other informational services for a manually driven vehicle. Additionally, the more precise determination of the vehicle location may provide for the improved navigation and control of an autonomous or semi-autonomous vehicle by taking into account the location of other objects, such as other vehicles, in proximity to the vehicle carrying the sensors.

The sensors on board vehicles therefore collect a wide variety of data that may be utilized for various purposes. However, these sensors currently on-board vehicles do have limitations and do not provide all of the different types of information that would be useful in various applications. One specific example of a current limitation is in the generation of alerts, scheduling data, route guidance, and automated vehicle controls in certain scenarios.

### BRIEF SUMMARY

A method, apparatus, computer readable storage medium, user interface, and computer program product are provided in accordance with an example embodiment to determine and predict the probability a given end user will attend a scheduled appointment, meeting, event, etc. In this regard, the method, apparatus, computer readable storage medium, and computer program product of an example embodiment may utilize data collected from and about end users, their location, their communications, and surroundings to determine and predict the likelihood a given end user will attend one or more appointments. The reliance upon the collection and analysis of end user data such as location and/or communication data may supplement the information provided by other sensors and allow for the provision of different information, such as the end user's typical travel (e.g., commuting) routine which is useful for a variety of applications. As an example, the determination of the on-going location of an end user may be useful in relation to the provision of more relevant information. Such uses include routing information, alerts, real time route guidance, etc.

A method for providing an appointment attendance probability system comprising obtaining an indication of least a first location and second location of an end user, wherein the first location and second location are obtained at a predefined time interval, obtaining end user driving profile data, obtaining end user appointment data and determining an appointment attendance probability indicator, score, etc. based, at least in part, on the obtained first location, second location, end user appointment data, and end user driving profile data. At least one database may then be updated with the determined appointment attendance probability.

Another embodiment of the method above may include the first location, or second location of an end user being captured at a dynamic time interval based on end user appointment data. The appointment attendance probability indicator determination may additionally include map data and/or traffic data. The indication of a first location or second location of the end user may be obtained from at least one electronic communication (e.g., email, electronic scheduling information/reminders, SMS, MMS, social media, etc.) in some embodiments.

Additionally, in some embodiments, the method may further comprise obtaining an indication of a location of a vehicle occupied by the end user. The determined appointment attendance probability indicator, score, value, information, data, etc. may be stored and updated in real-time based on additional information concerning the location of an end user, traffic, scheduling changes, etc. The determined appointment attendance probability indicator may be used to generate alerts and/or route guidance in some embodiments.

Another embodiment may be described as an apparatus configured to predict appointment attendance probability, the apparatus comprising at least one processor and at least one memory storing computer program code, the at least one memory and the computer program code configured to, with the processor, cause the apparatus to at least obtain an indication of least a first location and second location of an end user; wherein the first location data and second location data are captured at a predefined time interval, obtain end user driving profile data, obtain end user appointment data, and determine appointment attendance probability indicator(s) based, at least in part, on the obtained first location, second location, end user appointment data, and end user driving profile data. The apparatus may then update at least one database with the determined appointment attendance probability indicators(s).

This apparatus may, in some examples, feature the at least one memory and the computer program code being further configured to, with the processor, cause the apparatus to obtain an indication of the first location or second location of an end user at a dynamic time interval based on end user appointment data. The apparatus may also receive an indication of a first location or second location of an end user from at least one electronic communication (e.g., a social network, SMS, scheduling data, etc.). The apparatus may also be further configured to receive an indication of a location of the end user within a vehicle and update the determined appointment attendance probability indicator based, at least in part, on the indication of a location of the end user within a vehicle.

In further examples, the apparatus may also comprise determining appointment attendance probability indicator(s) based, at least in part, on real-time traffic data. The apparatus may also generate or update scheduling data, alerts, route guidance, etc. in response to a determined probability of appointment attendance.

Yet another embodiment may be described as a user interface for providing a user with a route to a destination, comprising the steps of receiving input upon a user device from the user that indicates a destination, accessing a geographic database to obtain data that represent roads in a region in which the user device is operating, determining a route to the destination by selecting road segments to form a continuous path to the destination, and displaying the determined route or portion thereof to the user, wherein the determined route avoids at least one road segment in response to a determined appointment attendance probability indicator.

In some embodiments, the user interface may avoid one or more vehicles proximate to the location of the end user based, at least in part, on a determined appointment attendance probability indicator. The user interface may also determine appointment attendance probability which is derived at least in part on location data of an end user.

All this UI information may be displayed on an end user device (e.g., smartphone, tablet, etc.) and/or in a motor vehicle (e.g., upon a built-in vehicle display).

In other embodiments, a UI may be provided which displays in real-time the determined appointment attendance probability indicator(s) for a given appointment as numerical scores or another visual element of the UI.

Also, a computer program product may be provided. For example, a computer program product comprising instructions which, when the program is executed by a computer, cause the computer to carry out the steps described herein.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment;

FIG. 2 is a block diagram of a geographic database of an example embodiment of the apparatus;

FIG. 3A is a flowchart illustrating the operations performed, such as by the apparatus of FIG. 1, in order for an apparatus to identify an appointment attendance probability indicator;

FIG. 3B is a flowchart illustrating the operations performed, such as by the apparatus of FIG. 1, in order to provide a graphical user interface and/or functions thereof;

FIG. 3C is a flowchart illustrating the operations performed, such as by the apparatus of FIG. 1, in order to train machine learning models to predict appointment attendance probability indicators;

FIG. 4A is a graphical representation of an end user exiting their home and approaching their vehicle while using the apparatus;

FIG. 4B is a graphical representation of a road upon which a passenger cars are present and the apparatus is in use.

### DETAILED DESCRIPTION

Some embodiments of the present invention will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A system, method, apparatus, user interface, and computer program product are provided in accordance with an example embodiment to determine an appointment attendance probability indicator based on various data sources. In order to determine appointment attendance probability indicator(s), the system, method, apparatus, non-transitory computer-readable storage medium, and computer program product of an example embodiment are configured to obtain an indication of least a first location and second location of an end user, wherein the first location and second location are obtained at a time interval, obtain end user driving profile data, obtain end user appointment data and determine appointment attendance probability based, at least in part, on the obtained first location, second location, end user appointment data, and end user driving profile data. At least one database may then be updated with the determined appointment attendance probability.

The system, apparatus, method, etc. described above may be any of a wide variety of computing devices and may be embodied by either the same or different computing devices. The system, apparatus, etc. may be embodied by a server, a computer workstation, a distributed network of computing devices, a personal computer or any other type of computing device. The system, apparatus, etc. configured to detect and predict appointment attendance may similarly be embodied by the same or different server, computer workstation, distributed network of computing devices, personal computer, or other type of computing device.

Alternatively, the system, etc. may be embodied by a computing device on board a vehicle, such as a computer system of a vehicle, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System (ADAS) of a vehicle), or any other type of computing device carried by the vehicle. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

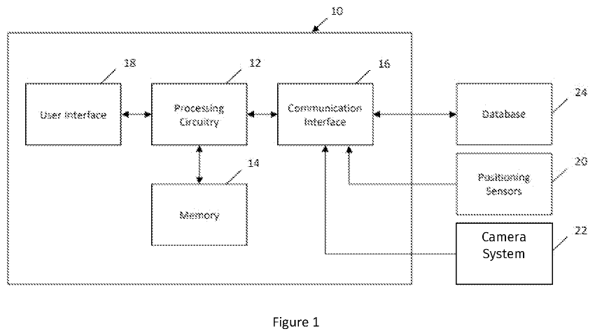

Regardless of the manner in which the system, apparatus, etc. is embodied, however, an apparatus 10 includes, is associated with, or is in communication with processing circuitry 12, memory 14, a communication interface 16 and optionally a user interface 18 as shown in FIG. 1. In some embodiments, the processing circuitry (and/or co-processors or any other processors assisting or otherwise associated with the processing circuitry) can be in communication with the memory via a bus for passing information among components of the apparatus. The memory can be non-transitory and can include, for example, one or more volatile and/or non-volatile memories. In other words, for example, the memory may be an electronic storage device (for example, a computer readable storage medium) comprising gates configured to store data (for example, bits) that can be retrievable by a machine (for example, a computing device like the processing circuitry). The memory can be configured to store information, data, content, applications, instructions, or the like for enabling the apparatus to carry out various functions in accordance with an example embodiment of the present disclosure. For example, the memory can be configured to buffer input data for processing by the processing circuitry. Additionally, or alternatively, the memory can be configured to store instructions for execution by the processing circuitry.

The processing circuitry 12 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally, or alternatively, the processing circuitry can include one or more processors configured in tandem via the bus to enable independent execution of instructions, pipelining and/or multithreading.

In an example embodiment, the processing circuitry 12 can be configured to execute instructions stored in the memory 14 or otherwise accessible to the processing circuitry. Alternatively, or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 10 of an example embodiment can also include the communication interface 16 that can be any means such as a device or circuitry embodied in either hardware or a combination of hardware and software that is configured to receive and/or transmit data from/to other electronic devices in communication with the apparatus, such as a database 24 which, in one embodiment, comprises a map database that stores data (e.g., one or more map objects, POI data, etc.) generated and/or employed by the processing circuitry 12. Additionally, or alternatively, the communication interface can be configured to communicate in accordance with various wireless protocols including Global System for Mobile Communications (GSM), such as but not limited to Long Term Evolution (LTE), 3G, 4G, 5G, 6G, etc. In this regard, the communication interface can include, for example, an antenna (or multiple antennas) and supporting hardware and/or software for enabling communications with a wireless communication network. In this regard, the communication interface can include, for example, an antenna (or multiple antennas) and supporting hardware and/or software for enabling communications with a wireless communication network. Additionally, or alternatively, the communication interface can include the circuitry for interacting with the antenna(s) to cause transmission of signals via the antenna(s) or to handle receipt of signals received via the antenna(s). In some environments, the communication interface can alternatively or also support wired communication and/or may alternatively support vehicle to vehicle or vehicle to infrastructure wireless links.

In certain embodiments, the apparatus 10 can be equipped or associated with one or more positioning sensors 20, such as one or more GPS sensors, one or more accelerometer sensors, one or more light detection and ranging (LiDAR) sensors, one or more radar sensors, one or more gyroscope sensors, and/or one or more other sensors. Any of the one or more sensors may be used to sense information regarding movement, positioning and location, and/or orientation of the apparatus for use, such as by the processing circuitry 12, in navigation assistance and/or autonomous vehicle control, as described herein according to example embodiments.

In certain embodiments, the apparatus 10 may further be equipped with or in communication with one or more camera systems 22. In some example embodiments, the one or more camera systems 22 can be implemented in a vehicle or other remote apparatuses. The camera systems 22 may include systems which capture both image data and audio data (via a microphone, etc.).

For example, the one or more camera systems 22 can be located upon a vehicle or proximate to it (e.g., traffic cameras, etc.). While embodiments may be implemented with a single camera such as a front facing camera in a consumer vehicle, other embodiments may include the use of multiple individual cameras at the same time. A helpful example is that of a consumer sedan driving down a road. Many modern cars have one or more cameras installed upon them to enable automatic braking and other types of assisted or automated driving. Many cars also have rear facing cameras to assist with automated or manual parking. In one embodiment of the current system, apparatus, method, etc. these cameras are utilized to capture images and/or audio of end users, vehicles, streets, etc. as an end user travels/moves around. The system, apparatus, etc. takes these captured images and/or audio (via the camera systems 22) and analyzes them along with other relevant data to determine a location of an end user on a certain street, area, etc. Images of end user communications may also be captured in some embodiments. It should be noted that various types of data such as end user location data and communication data/content may be detected via any functional means.

The data captured concerning an end user's location may also come from traffic cameras, security cameras, or any other functionally useful source (e.g., historic data, satellite images, websites, etc.).

The analysis of the image data, audio data, and other relevant data concerning end user communications, location, etc. may be carried out by a machine learning model. This model may utilize any functionally useful means of analysis to identify end user location on a given roadway, road segment, building, or in a general area. The system, in this embodiment, may also examine relevant proximate points of interest (POIs), map objects, road geometries, animate objects, etc. which could suggest potential end user location information or produce delays (e.g., end user drove from work to the hospital so they may no longer be on time for their dentist appointment).

The locations of an end user, their vehicle, any relevant points of interest (POIs), and other types of data which are utilized by various embodiments of the apparatus may each be identified in latitude and longitude based on a location of the end user and their vehicle using a sensor, such as a GPS sensor to identify the location of the end user's device (e.g., smart phone, smart watch, tablet, etc.) and/or the end user vehicle. The POIs, map objects, infrastructure, etc. identified by the system may also be detected via the camera systems 22.

In certain embodiments, information detected by the one or more cameras can be transmitted to the apparatus 10, such as the processing circuitry 12, as image data and/or audio data. The data transmitted by the one or more cameras, microphones, etc. can be transmitted via one or more wired communications and/or one or more wireless communications (e.g., near field communication, or the like). In some environments, the communication interface 16 can support wired communication and/or wireless communication with the one or more system sensors (e.g., cameras, etc).

The apparatus 10 may also optionally include a user interface 18 that may, in turn, be in communication with the processing circuitry 12 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processing circuitry may comprise user interface circuitry configured to control at least some functions of one or more user interface elements such as a display and, in some embodiments, a plurality of speakers, a ringer, one or more microphones and/or the like. The processing circuitry and/or user interface circuitry embodied by the processing circuitry may be configured to control one or more functions of one or more user interface elements through computer program instructions (for example, software and/or firmware) stored on a memory accessible to the processing circuitry (for example, memory 14, and/or the like).

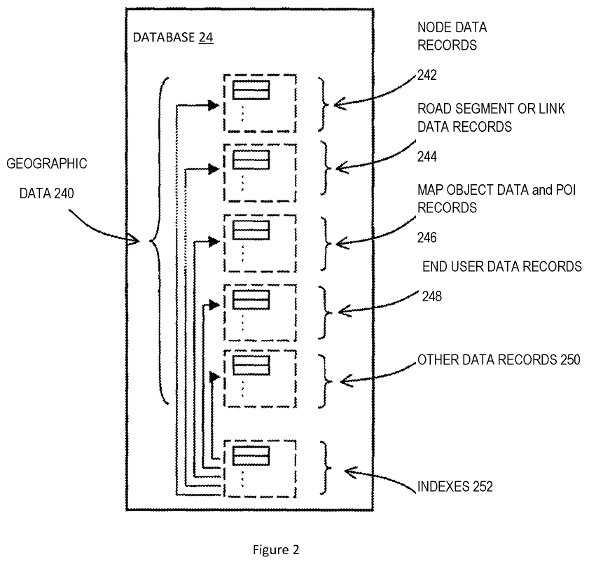

Turning to FIG. 2, the map or geographic database 24 may include various types of geographic data 240. This data may include but is not limited to node data 242, road segment or link data 244, map object and point of interest (POI) data 246, end user data records 248, or the like (e.g., other data records 250 such as traffic data, sidewalk data, etc.). Other data records 250 may include computer code instructions and/or algorithms for executing a machine learning model that is capable of providing a prediction of adverse road locations (as caused by the presence of the distractions from rushing to an appointment, reservation, etc). The other records may further include verification data indicating: (1) whether a verification of a prediction for appointment attendance was conducted; (2) whether the verification validates the prediction; or (3) a combination thereof.

In one embodiment, the following terminology applies to the representation of geographic features in the database 24. A “Node”—is a point that terminates a link, a “road/line segment”—is a straight line connecting two points, and a “Link” (or “edge”) is a contiguous, non-branching string of one or more road segments terminating in a node at each end. In one embodiment, the database 24 follows certain conventions. For example, links do not cross themselves and do not cross each other except at a node. Also, there are no duplicated shape points, nodes, or links. Two links that connect each other have a common node.

The map database 24 may also include cartographic data, routing data, and/or maneuvering data as well as indexes 252. According to some example embodiments, the road segment data records may be links or segments representing roads, streets, or paths, as may be used in calculating a route or recorded route information for determination of one or more personalized routes. The node data may be end points (e.g., intersections) corresponding to the respective links or segments of road segment data. The road link data and the node data may represent a road network, such as used by vehicles, cars, trucks, buses, motorcycles, bikes, scooters, and/or other entities.

Optionally, the map database may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database can include data about the POIs and their respective locations in the POI records. The map database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database.

The map database 24 may be maintained by a content provider e.g., the map data service provider and may be accessed, for example, by the content or service provider processing server. By way of example, the map data service provider can collect geographic data and dynamic data to generate and enhance the map database and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The map database 24 may be a master map database, such as an HD map database, stored in a format that facilitates updates, maintenance, and development. For example, the master map database or data in the master map database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map database 24 may be a master geographic database, but in alternate embodiments, a client-side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example. It should be noted the map database 24 may also include data regarding the interiors of buildings, homes, offices, etc. to aid the system, apparatus, etc. in tracking end user location as the end user moves around one location or between locations.

The records for end user data 248 may include various points of data such as, but not limited to: end user location data (at a first location, second location, etc.), end user communication data, end user appointment data, end user driving profile data (e.g., driving tendencies, etc.), data concerning a user's typical travel routine, and other end user data useful for determining appointment attendance probability.

The end user location data may, in some embodiments, include data obtained from GPS, NFC, Wi-Fi triangulation, cellular tower information, micro-mobility data, image data of the end user, facial and gait recognition (GRT) information, etc.

End user communication data may include information from SMS, MMS, email, social media, messaging apps, workplace applications like Slack, Microsoft Teams, Outlook, etc.

End user appointment/reservation/event data may, in some embodiments, include data about appointments, business or social meetings, events, reservations, etc. Scheduling information may come from scheduling software and websites such as Google Calendars, Outlook, Smartphone Calendars, HubSpot, Setmore, SimplyBook, Square Appointments, Appointlet, Doodle, Calendly, Acuity Scheduling, Calendar Hero. Restaurant reservation information may be obtained from website/tools like Resy, Wisely, Tock, and OpenTable. Event data for concerts, sporting events, social gatherings, etc. may be obtained from Ticketmaster, SongKick, etc. Event information may also be obtained from any relevant websites or databases.

End user driving profile data such as end user driving patterns (e.g., cautious, slow, fast, etc.) may be obtained by any functional manner including those detailed in U.S. Pat. Nos. 9,766,625 and 9,514,651, both of which are incorporated herein by reference.

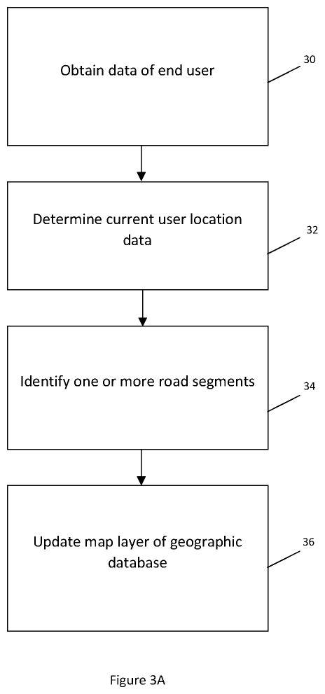

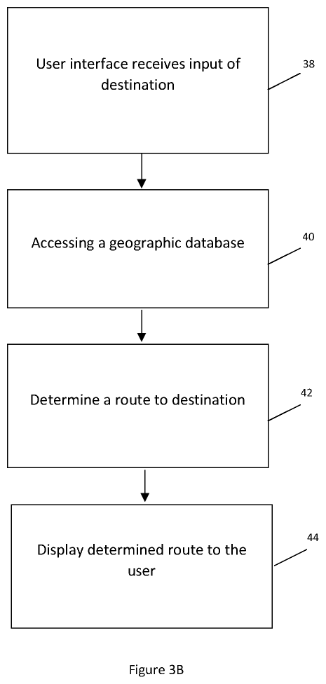

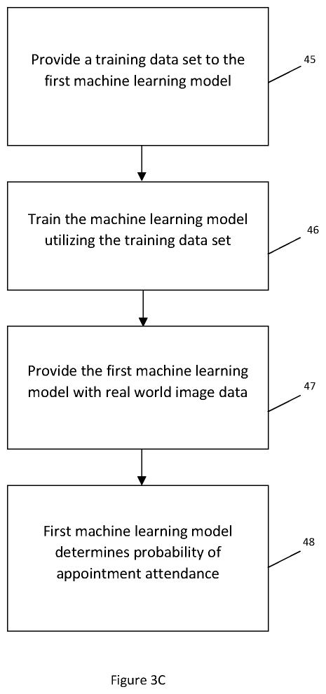

FIG. 3A is a flowchart which demonstrates how the apparatus 10 identifies an end user's location. More, fewer, or different acts or steps may be provided. At a first step (block 30) the apparatus may obtain one or more images, audio, or other data of at least one end user. This data may be obtained from an end user device via the camera and microphone of a device such as a smart phone. Data may also be obtained from various programs, apps, websites, etc., running on said end user device such as messaging apps, social media networks, scheduling applications and/or data, etc. Data may also be captured from the camera system of a vehicle or even traffic cameras, etc. The apparatus may be trained to analyze the data (see FIG. 3C) via machine learning model or any other functionally capable means to identify/predict the end user's location at a given time and thus their likelihood of being on time for an appointment.

The data captured by the system may include but is not limited to location (GPS) data, the content and context of end user electronic communications, metadata about an end user, actual images or audio data of end users in various contexts (e.g., within their home or office, approaching their vehicle, in their vehicle, etc.). The presently disclosed system, apparatus, etc. may monitor, track, etc. the location of an end user at various locations throughout their day, when they travel outside a predefined area, etc.

For example, if an end user makes a hair appointment on a given day, the end user's presence ten, one hundred, or one thousand miles away from the location of the appointment made on the day in question could impact the chances they will be attending said appointment. This this in mind, in some embodiments, the presently disclosed apparatus might check the location of an end user on the day before their hair appointment and the day of their hair appointment. If the end user is within an acceptable range from the hair salon where the appointment was made (e.g., one mile away) the apparatus 10 might generate a favorable appointment attendance probability indicator in the form of a score (e.g., 80%) which can then be used to alert the hair salon that the given end user will likely be on time for their appointment.

This indicator (e.g., a score in this example) can be impacted by various factors such as traffic in the area of the salon or of the end user. In this embodiment traffic data may be obtained from the database 24 and/or real-time external data sources. Changes to the appointment attendance probability score can be relayed to the hair salon in real time to inform the salon the given end user might be early, on-time, late, or even miss the appointment entirely.

Once the data (e.g., the end user data) is obtained the apparatus 10 may then determine the location of an end user (block 32). For example, if the end user with a hair appointment leaves their home or a restaurant and enters their vehicle (confirmed by image data, geolocation data, NFC data, nearby hotspots, etc.) the apparatus 10 will note the end user now occupying a car and may update the appointment attendance probability indicator score (e.g., now 90%). This is because the presence in their car indicates they may likely be headed to the appointment.

Once the end user's location has been identified, the apparatus may then identify one or more road segments (block 34) upon which the end user is traveling. The identification of the relevant road segments may be done via a vehicle's onboard GPS (see FIG. 1) or any other functional means. Once identified, the apparatus may then update the confidence score even further based on the direction the given end user is traveling (e.g., towards the appointment) as well as other factors such a real-time traffic data. The apparatus may also update a map layer of a geographic database (block 36). This data can be used by various end users, including other drivers who may want to avoid someone rushing to an appointment for which they are late.

The updating of the map layer may include but is not limited to identifying/associating locations of the identified relationships with certain road segments and then providing a data indicator or flag to mark that road segment or attribute (metadata) that can be used as an identifier when needed to access or retrieve the road segments for various navigation functions. This data can also be used to generate alerts and analyze other similarly situated road segments for the potential risk, route changes, etc. a given indicator might pose. The road segment data may also include sidewalk data or areas included in/associated with the road segment records or the road segment records may represent path records such as sidewalks, hiking trails, etc.

Turning to FIG. 3B, the apparatus 10 may support a user interface 18 (as shown in FIG. 1). More, fewer, or different acts or steps may be provided. At a first step, the user interface may receive an input of destination from an end user (block 38). This input of destination may be received via an end user device graphical user interface (GUI) running upon a smartphone, tablet, integrated vehicle navigation system, etc. Once a destination is input, the apparatus may then access a geographic database (block 40) and determine a route to the input destination (block 42). The determined route may, in some embodiments, avoid at least one road segment in response to a determined appointment attendance probability indicator(s). As mentioned above, the determination of the indicator may be based on any functionally capable means including identification of an end user in multiple locations (e.g., at home and continued in a car) and predicting a score based on these end user location(s), world/life events, end user communications, and/or various other data sources.

Notwithstanding how the apparatus generates a determination of an attendance probability indicator, this information may then be used to route an end user towards or away from certain road segments when generating a route. The route determined by the apparatus 10 may then be displayed to the end user (block 44) via the same or a different user interface. The apparatus can take any number of additional actions (or in place of) what is called for in block 44. For example, the apparatus may provide audio guidance instead of a visual display. The navigation instructions may also be provided to an autonomous vehicle for routing (for example, without any display to the user). It should also be noted the UI can be run by a processor and stored upon one or more types of memory in some embodiments.

Referring now to FIG. 3C, the operations performed, such as by the apparatus 10 of FIG. 1, in order to train a machine learning model to detect and/or predict appointment attendance probability indicators. More, fewer, or different acts or steps may be provided. As shown in block 45, the apparatus 10 includes means, such as the processing circuitry 12, memory 14, the communication interface 16 or the like, for providing a training data set that includes a plurality of training examples. In this regard, the training data set may be provided by access by the processing circuitry of the training data set stored by the memory. Alternatively, the training data set may be provided by access by the processing circuitry to a database 24 or other memory device that either may be a component of the apparatus or may be separate from, but accessible to the apparatus, such as the processing circuitry, via the communication interface. It should be noted the system apparatus may utilize more than one machine learning model to carry out the steps described herein.

In accordance with an example embodiment, the apparatus 10 also includes means, such as the processing circuitry 12, the memory 14 or the like, configured to train a machine learning model utilizing the training data set (block 46). The machine learning model, as trained, is configured to detect and predict appointment attendance indicators. The prediction may be based, at least in part, upon end user location data. This data may be obtained from a conversation engaged in by at least one end user upon an end user device such as a smartphone, tablet, computer, etc. in some embodiments.

The apparatus 10, such as the processing circuitry 12, may train any of a variety of machine learning models to identify appointment attendance indicators based upon a single or plurality of data points, images, audio, etc. Examples of machine learning models that may be trained include a decision tree model, a random forest model, a neural network, a model that employs logistic regression or the like. In some example embodiments, the apparatus, such as the processing circuitry, is configured to separately train a plurality of different types of machine learning models utilizing the same training data including the same plurality of training examples. After having been trained, the apparatus, such as the processing circuitry, is configured to determine which of the plurality of machine learning models predicts appointment attendance indicators with the greatest accuracy. The machine learning model that has been identified as most accurate is thereafter utilized.

In one example, the machine learning model may be a deep learning neural network computer vision model that utilizes user location data, communication data, scheduling data, etc. to automatically identify appointment attendance probability indicators. A training example for this first machine learning model may include data demonstrating known travel patterns, routines, etc. for end users. For example, if an end user has a typical travel routine for work (Monday-Friday) such as driving to an office building (or other POI(s)) each day and then driving home later in the day the machine learning model can be provided this set of location data to act as baseline for the location of an end user. If an end user then has to travel out of town on a given Tuesday, the model will be able to detect the departure from the normal travel routine based on the new location data of the end user. If the end user travels far enough away from the area in which they have an appointment scheduled, the model may determine this is an indicator that a given end user will not attend certain appointment(s) on that day.

The content of the discussions and other data (e.g., Outlook scheduling data) may also be categorized and utilized by the model. For example, discussions about topics like travel, life events, etc. may indicate a given end user can no longer make a scheduled appointment. These various types of discourse and metadata about them may be provided to the machine learning model to train and improve its accuracy.

In some example embodiments, a balance or trade-off between the accuracy with which the appointment attendance probability indicators are identified and the efficiency with which the machine learning model identifies them is considered. For example, a first set of data, images, audio, etc. may produce the most accurate identification, but a second combination of data, images, audio, etc. may produce an identification of appointment attendance indicators (e.g., GPS data, image data, scheduling data.) that is only slightly less accurate, but that is significantly more efficient in terms of its prediction. Thus, the second combination of data that provides for sufficient, even though not the greatest, accuracy, but does so in a very efficient manner may be identified by the apparatus 10, such as the processing circuitry 12, as the preferred data about end users to be provided to the machine learning model to identify appointment attendance indicators in subsequent instances.

In some embodiments, a training example also includes information regarding a map object, such as a map object that is located at the location at which the data concerning end user communication was captured. One example of a map object is a bridge, and another example of a map object is a railroad crossing or median. A wide variety of other map objects may exist including, for example, manhole covers, transitions between different types of road surfaces, medians, parking meters, various forms of infrastructure, or the like. As described in more detail below, the map object that is included in a training example may be determined or provided in various manners. For example, the map object may be defined, either manually or automatically, by reference to a map database 24 and identification of a map object at the same location or at a location proximate, such as within a predefined distance of, the location at which the corresponding image data was captured. The training example may also include point of interest (POI) data. A POI may be something like a hospital, restaurant, park, school, bus stop, etc. Relevant POIs may also be defined, either manually or automatically, by reference to a map database 24 and identification of a POI at the same location or at a location proximate, such as within a predefined distance of, the location at which the corresponding image data was captured. The location of relevant POIs and/or map objects may be found by GPS coordinates or any other functionally capable means.

Yet other various types of data may also be utilized when training the machine learning model including map geometry data, historic data, indoor mapping data, geolocation data, Wi-Fi mapping (e.g., triangulation) data, hotspot data, etc. Ground truth data may also be utilized with a combination of these different features for supervised machine learning.

It should also be noted in some examples the apparatus, system, etc. may monitor both sides of a conversation. As mentioned above, the apparatus may examine one end user's inputs, posts, text messages, etc. to determine their present or future location. In some embodiments, the apparatus may monitor and analyze this same data (and other information) for one or more additional end users to determine if any other end user, engaged in a conversation with the first end user, may influence or create appointment attendance probability indicator(s).

Once trained, the machine learning model may then be provided various real-world data as mentioned in block 47 and used to determine appointment attendance probability indicators (which may also be described as appointment attendance indicators, attendance indicators, etc. in some embodiments) based on the various data points above and others (block 48).

An example of the apparatus 10 detecting and/or predicting an appointment attendance indicator is that of an end user receiving bad news about a family member. The end user may receive a text from their parent stating “Aunt May is Sick!”. The apparatus 10 may observe the actual content of the text message and compare it to one of more databases of known communications to determine if this message has the potential to create or impact appointment attendance. The system may also observe the end user's response to the message. For example, if the end user responds: “On my way to Aunt May's house!” there is an indication that this conversation is altering the end user's plans for the day as well as their potential location.

The end user's location may also be tracked and confirmed by the apparatus 10. Appointment data for the end user may also be stored and analyzed by the apparatus 10. In this example, the end user had a doctor's appointment scheduled on the day they received the text message regarding their sick family member. Since the end user has indicated in their text message that they are headed to their family member house the apparatus 10 may combine this observation with the appointment scheduling information to conclude that the end user might not make their appointment (or be late for said appointment) depending on the location of the family member's house. This location may be confirmed by GPS data, geographic database, etc. and thus the determination based on at least one end user location, one end user communication, and end user scheduling data may serve as an appointment attendance probability indicator.

After receiving the SMS text message above, the end user may then approach and enter a vehicle. The apparatus 10 may keep track of the end user by way of geolocation data, image data of the end user entering a vehicle captured by a camera system, an end user device pairing with vehicle Bluetooth or Wi-Fi of a vehicle, etc. As the end user drives their vehicle (e.g., a car) down a given road link, the apparatus 10 may continue to observe the end user to determine if the end user is traveling away from the location of a scheduled appointment. The apparatus 10 may achieve this by any functional means including continuing to monitor GPS data at various time intervals, etc.

The apparatus 10 may also continue to monitor GPS location information, text messages, social media posts, etc. to update the determined appointment attendance probability indicator. For example, continuing with the example above, if an end user enters their car and drives towards the location of their appointment and not towards the location of their sick relative's home (as confirmed POI data, GPS data, etc.) the apparatus 10 may update the appointment attendance indicator to account for the improved chances the end user will be attending their appointment. The appointment attendance indicator may be further bolstered by a subsequent SMS message sent by the end user which states “I will come to Aunt May's after my doctor appointment.”

The machine learning model in this example makes its determination based on a combination of specific factors (map data, communication data, image data, location data, scheduling data, etc.), and the model predicts the potential of appointment attendance (e.g, appointment attendance probability indicator(s)) because of specific factors in a specific combination or configuration are present. The factors in this example may include data extracted from the text sent to an end user, the end user's physical location at various times (e.g., a first time and second time), image data of the end user leaving their home and entering a vehicle, image data of roadways, image data of other vehicles on the roadways, as well as time of day data, historic data, etc. This set of data, provided to the model, matches (or is like) the factors used in the training process (in this example). This allows the machine learning model to predict if an end user is likely to attend an appointment at a given location based on the end user's current and past locations, time of day, vehicles or end users present, etc.

The determination of one or more appointment attendance probability indicators can then be utilized in various ways. The apparatus 10 may alert end users via graphical user interface that they could be at risk of missing their appointment(s). The apparatus 10 might also inform other end users in proximity to a given end user who is late for an appointment to be cautious as the end user who is late for an appointment might be in a rush and driving less cautiously. The apparatus may also update one or more map layers and/or databases to account for this determination. In some embodiments, the identified location of an end user who is likely to miss (or make) an appointment may be used to activate autonomous or highly assisted driving features. For example, if the vehicle discussed above had self-driving capabilities the apparatus 10 could activate a self-driving mode in response to the appointment attendance probability indicators to avoid potential rushed driving from an end user. The end driver in a rush to make their appointment might also use automated driving to reach the appointment in the most efficient manner possible to minimize a late arrival.

As mentioned before, the apparatus 10 features one or more machine learning models. This model and other data may be used by the apparatus 10 to not only analyze real time driving situations as mentioned above but also examine existing map data to identify other similarly situated roadways. These similar roadways will have similar POIs, map objects, etc. So, for example, if there was a roadway with which leads to a hospital upon which users late for an appointment typically speed, the apparatus 10 may be able to detect similar roadways in other areas and provide alerts, route guidance, etc. to an end user to avoid the potential risk.

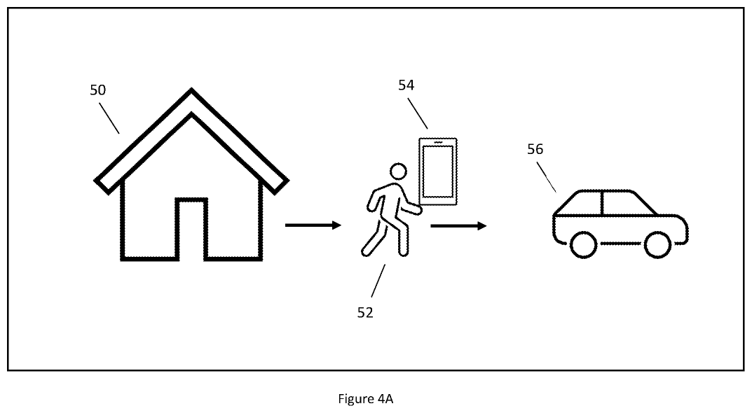

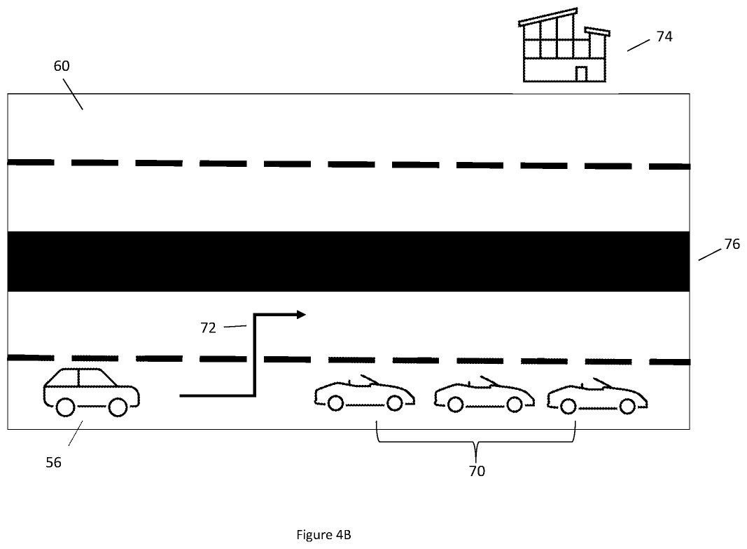

Turning to FIG. 4A, some of the examples discussed above are illustrated. Specifically, an end user 52 is shown exiting their home 50 and approaching their sedan 56. As shown in FIG. 4A, the end user 52 is utilizing the apparatus 10 upon their end user device 54 to detect and/or predict appointment attendance probability indicators. The apparatus 10 identifies the user's location (moving from house to car) via images from the camera system 22, traffic cameras, etc. and feeds those images into the machine learning model along with other data such as information concerning if the end user has any upcoming appointments and their potential location in the near future (potentially obtained from electronic conversations/interactions, scheduling data, etc.). The apparatus then takes this data along with relevant other information such as the image data of roads in the area, etc. and feeds all the data to the machine learning model (or to another model, algorithm, etc.) to determine if the given end user will be on time for one or more appointments.

It should be noted that the sedan 56 in this example may represent any vehicle. Such vehicles may be standard gasoline powered vehicles, hybrid vehicles, an electric vehicle, a fuel cell vehicle, and/or any other mobility implement type of vehicle (e.g., bikes, scooters, etc.). The vehicle includes parts related to mobility, such as a powertrain with an engine, a transmission, a suspension, a driveshaft, and/or wheels, etc. The vehicle may be a non-autonomous vehicle or an autonomous vehicle. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one embodiment, the vehicle may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

In one embodiment, a graphical user interface (GUI) may be integrated in the vehicle, which may include assisted driving vehicles such as autonomous vehicles, highly assisted driving (HAD), and advanced driving assistance systems (ADAS). Any of these assisted driving systems may be incorporated into the GUI. Alternatively, an assisted driving device may be included in the vehicle. The assisted driving device may include memory, a processor, and systems to communicate with the GUI. In one embodiment, the vehicle may be an HAD vehicle or an ADAS vehicle. An HAD vehicle may refer to a vehicle that does not completely replace the human operator. Instead, in a highly assisted driving mode, a vehicle may perform some driving functions and the human operator may perform some driving functions. Such vehicle may also be driven in a manual mode in which the human operator exercises a degree of control over the movement of the vehicle. The vehicle may also include a completely driverless mode. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In this example, the end user 52 has an appointment for an outpatient surgery the following day. The apparatus 10 may obtain various pieces of data about the appointment such as the scheduled time/date, the location, and various other pieces of data and/or metadata such as the importance of the appointment. The importance of the appointment data might be indicated by an end user manually or automatically detected by the apparatus 10 via machine learning or any other functionally capable means. For example, a surgical appointment or doctor's appointment might be given more weight/importance than a haircut appointment or dinner reservation. The importance of the appointment might, in some embodiments, influence the time interval or number of times an end user's location is checked prior to an appointment. For example, for a haircut appointment, the end user's location might be measured a few hours before an appointment and then again, a few minutes before the appointment. These first and second time points during which the location of an end user is captured may help determine if the end user is likely to attend their haircut. If the end user was to miss a haircut, the impact is likely low whereas with a surgery or cancer treatment, there may be a higher importance the end user attends their appointment. Given the higher stakes indicated to or determined by the apparatus 10, some embodiments of the present apparatus 10 may assess the location of an end user at dynamic time interval(s) as determined to be the best time interval which accurately (and/or efficiently) predicts if an end user will be attending a certain type of appointment.

For example, if an end user is to have surgery as discussed above, the apparatus 10 might measure the end user's location every day for a week leading up to the appointment to be sure they are consistently in an area or location from which it is feasible to travel to the location of the surgery appointment. The threshold for proximity to a given appointment location may be predefined (e.g., 100 feet, 100 miles, etc.) or determined by a machine learning model based on historic data regarding end user location(s) and how they correlate to appointment attendance.

The distance threshold may also be adjusted over time based on feedback concerning appointment attendance. In some embodiments, the number of location data points collected for a given end user leading up to an appointment might provide greater accuracy. In others, the time interval between location data point measurements may provide better accuracy. It is fully envisioned some embodiments of the present innovation may detect and adjust the number, timing, etc. of location data points collected for a given end user leading up to an appointment to optimize appointment attendance predictions.

In some embodiments, the apparatus 10 may extract information from the communications of an end user by use of OCR and/or NLP. In one embodiment, the apparatus 10 may use optical character recognition (“OCR”) in conjunction with one or more databases (see FIG. 2) to determine text or characters of a message. Additionally, the apparatus 10 may compare features or components (such as invariant components relating to an emoji) in or from images to reference features or components in one or more reference databases (or data libraries) to detect a symbol or feature (such as angry emojis, exclamation points, etc.). The apparatus 10 may then record (in a database) the determined text, the identified symbols and/or graphics thereof, and/or other features or determinations. For example, the end user 52 may be typing on their device 54 as they walk to their car a phrase such as “I am headed out of town for the long weekend”. The apparatus 10 can extract this text along with any exclamation points, emojis, etc. and use this information to determine the message's meaning and content, at least in part, by comparing the message's content to a current database of reference information.

As mentioned above, OCR may be used to extract the information from an end user message and natural language processing (NLP) technologies may be used in conjunction with the OCR tools to aid the apparatus 10 in analyzing the messages. NLP may be used in some embodiments to address issues around word segmentation, word removal, and summarization to determine the relevancy of the various parsed data. In various embodiments, semantics of the various parsed data are determined based on a vocabulary model in a grammar module. For example, in various embodiments, probabilistic latent semantic indexing (pLSI) or Latent Dirichlet allocation (LDA) may be used to deduce semantics from words in the extracted message information and determine the information's relevancy. Such methods can be used to derive text and topics from a set of predefined terms.

Based off this information, the apparatus may provide to the end user 52 an alert (e.g., risk of missing an important appointment alert). The information may also be used to provide route guidance 72 (see FIG. 4B below) or alerts to other user(s) in the area. The suggested route changes may mitigate the risk while in some other examples, automatic braking, etc. may be applied by the apparatus 10 to avoid risky situations created by someone rushing to an appointment.

Route guidance may include various guidance options, visual and/or audio. For example, visual guidance on how and when to change lanes or audio guidance relaying the same information. Automatic driver controls like those for an autonomous vehicle (e.g., an automatic lane change that can include an explanation to the passenger on what is happening), etc. The guidance itself can include the alert messages as mentioned above so the generation of alerts and route guidance can be the same function. When calculating the route and route guidance, metadata such as a data flag or attribute of road segments are taken into consideration when forming different suggested routes and one or more segments may be excluded from these routes when it is determined (by the apparatus) that one or more appointment attendance probability indicators are associated with the omitted segment(s).

In some embodiments, apparatus 10 may generate a confidence interval/score which reflects the likelihood an end user will attend an appointment. In the example above, the apparatus 10 can detect an end user communication and extract relevant information such as the end user's weekend plans to be out of their typical location. From this information, the confidence score for the likelihood of an end user attending their appointment may be decreased from 1 to 0.5. The apparatus 10 may then receive additional information from other sources (e.g., ongoing updates to end user location data, metadata about the conversation, other cars present on a roadway, traffic camera data, traffic alerts, real-time driving behavior of the end user, etc.) which can increase or decrease this confidence score. For example, if there is image data of end user driving down a roadway away from the appointment location the apparatus 10 might lower the confidence score for the likelihood of attendance from 0.5 to 0.25. Alternatively, if the end user is instead driving towards their scheduled appointment, the confidence interval may be boosted up to 0.75 as the end user might be attending their scheduled appointment then heading out of town (as indicated by their text message). This confidence interval can be updated in real time and is useful for numerous tasks including keeping/providing an accurate real time record for businesses, etc. which rely on appointments.

It should be noted that the confidence interval/score described above may itself act as an appointment attendance probability indicator and may also be used as part of a greater analysis and combined with other factors when determining one or more appointment attendance probability indicator(s).

FIG. 4B illustrates another example embodiment. Specifically, the sedan 56 from FIG. 4A is shown driving down a roadway 60. As shown in FIG. 4B, the sedan 56 is utilizing the apparatus 10 to predict if the end user occupying the sedan 56 will be on time for their appointment. The apparatus 10 identifies the sedan 56 based on the information discussed above and feeds the data, images, etc. into a machine learning model which determines the likelihood the end user driving the sedan 56 will make it to a given appointment on time (or at all). In this example, there is additional traffic 70 on the roadway 60 which could impact the time of arrival for the end user. The appointment, in this example, is at an office building 74 along the roadway. Also worth noting is the presence of a median 76 (a map object) which, in addition to the traffic, further hampers the sedan 56 on its way to the office building 74. The apparatus 10 may observe these road obstacles (traffic 70 and median 76) via any functional means such as image data, traffic reports, etc.

The apparatus 10 takes the road obstacle data along with relevant other information such as the appointment time and location, end user location, end user driving habits, vehicle information (e.g., gas level, tire pressure, etc.) and generates alerts, routing information, etc. in response. In this example, the routing guidance 72 is shown as an arrow representing guidance to avoid the traffic 70 for the sedan 56 (e.g., a suggestion to drive around the traffic in the other lane). Alternatively, the other vehicles present on the roadway 60 could also be routed around the sedan 56 which is potentially late for an appointment to avoid a rushed driver and/or make sure the driver reaches their destination on time (or minimizes their lateness).

As mentioned in the discussion for FIG. 4A, a confidence interval may be generated based on the likelihood that the end user attends a given appointment on time. With the instant example, the apparatus 10 may attribute a confidence score of 0.75 based on the presence of the sedan 56 relatively close to the office building 74 and the various factors known (e.g., driver is speeding to their appointment, there is a clear route around traffic to the appointment, etc.). This score can also be based in part on historical data concerning which vehicles and/or drivers that most commonly make their appointments on time. For example, many elderly drivers may drive more slowly so the confidence score, in this example, might be reduced to 0.60 if the end user of the sedan 56 is an older (and close to running late for their appointment).

In another example, the apparatus 10 may be used by a popular restaurant to keep track of reservation attendance likelihood. In this example, a popular restaurant may have a full book of reservations and run on a small budget. This means each reservation is very important and if a table was to no-show for a reservation, it could mean a good deal of lost money for the restaurant. Thus, the apparatus 10 may be integrated or communicate with the restaurant's website to obtain data regarding the reservations scheduled for the week. If a given end user has booked a dinner reservation on Friday at 7 PM, the apparatus 10 may (with the permission of the end user(s)) track the end user's location data, communication data, personal scheduling data, etc. to determine if the end user will likely attend the dinner reservation or not. The apparatus 10 may monitor the end user(s) location via GPS data obtained from their smartphone, vehicle, etc. at predefined time intervals (e.g., at a first time, at a second time, third time, etc.) prior to the scheduled dinner reservation. This predefined time interval may be adjusted by the apparatus 10 over time based on feedback obtained about which end users attend their scheduled appointments, etc. and other relevant factors.

In this example, the apparatus 10 observes the end user's location one hour before their reservation (6 PM on Friday) and then 10 minutes before the reservation (6:50 PM on Friday). Based on the location of the end user as confirmed by GPS data, image data, etc. the apparatus 10 may then also examine other data and/or metadata about the end user, their location, their vehicle, etc. to further establish or adjust one or more appointment attendance probability indicators. If the end user works in the city and the reservation is in the suburbs, the apparatus 10 may observe the end user's location at 6 PM in the city as not negatively impacting the probability the end user will attend their dinner reservation. The information about the end user's work location and typical travel patterns may be observed by the apparatus 10 over time with the data stored in one or more databased of end user data (discussed above in FIG. 2). The apparatus 10 may then also observe the end user's location 10 min before their reservation. When the measurement is taken at 6:50 PM, if the end user is still at their office in the city (or a different location which is out of their normal travel routine) the apparatus may lower the assessed probability that the given end user will attend their dinner reservation.

Alternatively, if the end user's location at 6:50 PM is observed as closer to the restaurant, the apparatus 10 may increase its probability assessment for the end user attending the given reservation. The apparatus 10 may also utilize other factors such as vehicle information. For example, the apparatus 10 may examine if there is enough gas in the end user's car to reach the restaurant from the end user's current observed location. Yet other data such as real-time traffic data, weather data, and end user driving profile data may also be used to determine appointment attendance probability indicator(s)/score(s). Continuing with this example, if the end user has little gas in the car they will likely have to stop and get gas before the dinner reservation so an alert may be generated by the apparatus 10 and allow the end user and/or the restaurant to adjust or cancel the reservation. This same adjustment may also be made in response to an end user who drives very slowly (as confirmed by a profile of historical and/or real-time end user driving data) or is commonly late for appointments and thus may be late for their dinner reservation.

Traffic on a given roadway leading to the restaurant (in this example) may also be a factor impacting the end user's probability of attending a reservation. If traffic is congested on the roadway upon which the location of the end user is observed at 6:50 PM in this example, the apparatus 10 may enable the end user and/restaurant to adjust or cancel the reservation. The apparatus 10 may also provide route guidance to the end user who made the reservation to reach their appointment on time or minimize their late arrival (and inform the restaurant of the late arrival). In some embodiments, the apparatus 10 may also alert and/or route other vehicles in the area away from the vehicle occupied by the end user headed to an appointment. This may be done to help the end user arrive on time (or minimize lateness) and/or lower the risk to surrounding vehicles as in some cases the end user who is traveling to an appointment might be rushing and drive less carefully.

In yet another example, the apparatus 10 may also use data or metadata about a given appointment and end user to predict the likelihood of appointment attendance. For example, if someone has an appointment at 6 AM and they normally awaken at 8 AM (based on phone usage data, smartwatch data, fitness tracker info, image data, etc.) the apparatus 10 may lower the confidence interval based on this potential that the end user will sleep in and miss the appointment outside their normal waking hours.

In yet another example, the apparatus 10 may also account for anyone who is due to attend a scheduled appointment within a vehicle. A passenger (e.g., a child) may also need to be at an appointment, school, etc. on time and if this passenger is running late, it can potentially cause an end user to rush and thus the apparatus 10 may generate alerts, routing, etc. for anyone in a vehicle running late for an appointment.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an embodiment of the present invention and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing an appointment attendance probability system comprising:
obtaining an indication of least a first location and second location of an end user; wherein the first location and second location are obtained at a predefined time interval;
obtaining end user driving profile data;
obtaining end user appointment data;
determining appointment attendance probability indicator based, at least in part, on the obtained indication of first location, indication of second location, end user appointment data, and end user driving profile data; and
updating at least one database with the determined appointment attendance probability indicator.

2. The method according to claim 1, wherein the first location or second location of an end user is captured at a dynamic time interval based on end user appointment data.

3. The method according to claim 1, wherein the appointment attendance probability indicator determination additionally includes map data.

4. The method according to claim 3, wherein the appointment attendance probability indicator determination additionally includes traffic data.

5. The method according to claim 1, wherein the indication of a first location or second location of the end user is obtained from at least one electronic communication.

6. The method according to claim 1, further comprising obtaining an indication of a location of a vehicle occupied by the end user.

7. The method according to claim 1, further comprising providing an alert and/or route guidance in response to the determined appointment attendance probability indicator to at least one end user device.

8. The method according to claim 1, further comprising updating a determined appointment attendance probability indicator stored in at least one database in response to obtaining at least one additional indication of end user location.

9. An apparatus configured to predict appointment attendance probability, the apparatus comprising at least one processor and at least one memory storing computer program code, the at least one memory and the computer program code configured to, with the processor, cause the apparatus to at least:
obtain an indication of least a first location and second location of an end user; wherein the first location data and second location data are captured at a predefined time interval;
obtain end user driving profile data;
obtain end user appointment data;
determine an appointment attendance probability indicator based, at least in part, on the obtained first location, second location, end user appointment data, and end user driving profile data; and
update at least one database with the determined appointment attendance probability indicator.

10. The apparatus according to claim 9, wherein the at least one memory and the computer program code are further configured to, with the processor, cause the apparatus to obtain an indication of the first location or second location of an end user at a dynamic time interval based on end user appointment data.

11. The apparatus according to claim 9, wherein the at least one memory and the computer program code are further configured to, with the processor, cause the apparatus to receive an indication of a first location or second location of an end user from at least one electronic communication.

12. The apparatus according to claim 11, wherein the at least one memory and the computer program code are configured to, with the processor, cause the apparatus to obtain the data of at least one electronic communication from a social network.

13. The apparatus according to claim 9, wherein the at least one memory and the computer program code are further configured to, with the processor, cause the apparatus to receive an indication of a location of the end user within a vehicle.

14. The apparatus according to claim 13, further comprising updating the determined appointment attendance probability indicator based, at least in part, on the indication of a location of the end user within a vehicle.

15. The apparatus according to claim 9, wherein the determined appointment attendance probability indicator is based, at least in part, on real-time traffic data.

16. The apparatus according to claim 9, wherein the at least one memory and the computer program code are configured to, with the processor, cause the apparatus to generate or update scheduling data.

17. A user interface for providing a user with a route to a destination, comprising the steps of:
receiving input upon a user device from the user that indicates a destination;
accessing a geographic database to obtain data that represent roads in a region in which the user device is operating;
determining a route to the destination by selecting road segments to form a continuous path to the destination; and
displaying the determined route or portion thereof to the user,
wherein the determined route avoids at least one road segment in response to a determined appointment attendance probability indicator.

18. The user interface of claim 17, wherein the route determined for the end user avoids one or more vehicles proximate to the location of the end user based, at least in part, on a determined appointment attendance probability indicator.

19. The user interface of claim 17, wherein the determined appointment attendance probability indicator is derived at least in part on location data of an end user.

20. The user interface of claim 17, wherein the user interface is displayed in a motor vehicle.
